(19) United States
(12) Patent Application Publication
(10) Pub. No.: US 2010/0246782 A1
(43) Pub. Date: Sep. 30, 2010

(54) Picture Phone Interactive Voice Response System and Method

(75) Inventor: Douglas M. Grover, Westminster, CO (US)

Correspondence Address: AVAYA INC.;MARGARET CARMICHAEL, DOCKETING SPECIALIST, 1300 W. 120TH AVENUE, ROOM B1-F53, WESTMINSTER, CO, 80234, US

(73) Assignee: Avaya Inc., Basking Ridge, NJ (US)

(21) Appl. No.: 12/411,955

(22) Filed: Mar. 26, 2009

(51) Int. Cl. H04M 1/64

(52) U.S. Cl. 379/88.04; 379/88.25

(57) ABSTRACT

Disclosed is a simplified interactive solution for providing access to back-end services. A communication is established from a communication device to a processing system. The processing system receives a picture from the communication device. The user is presented with tasks (services to perform on the picture) on an IVR menu in an Interactive Voice Response (IVR) system. The user responds by choosing a task to perform on the picture. The task is then performed on the picture. Some of the tasks that can be performed are to generate postcards/greeting cards based on pictures. These can be combined with other services such as photo processing services/delivery services to provide a rich set of services to the user.

### TECHNICAL FIELD

The system and method relates to communication devices that can take pictures and in particular to picture processing services for communication devices.

### BACKGROUND

Currently, camera phones are very limited in providing voice recognition software/services because of the expense in doing voice processing on the phone. Current options for handling pictures from a mobile communication device include sending a picture using Multi Messaging Services (MMS). MMS allows a picture to be tagged with voice/email/text messages. The MMS messages then can be sent to other users. However, this solution does not offer a simple solution for interfacing with back-end processing services.

Other solutions for processing pictures include downloading the pictures from a picture phone/digital camera to a computer. The user can then use a web site such as Walgreens™ that allow the user to download the pictures to a photo processing service via a web site. The user can then go to their local Walgreens™ store and get the photographs that were developed from the picture. This process is cumbersome and the user does not have a simple interface to access back-end processing services. Multiple steps are required when accessing back-end processing services.

Other systems such as disclosed in U.S. Pat. No. 6,369,908 describe a photo kiosk for electronically creating, storing, and distributing images, audio and textual messages. This patent discloses a kiosk that does the equivalent of MMS. The system allows the user to take a picture and then attach a banner (predefined message) to the image. In addition, the system allows the user to attach voice and text messages in conjunction with the picture. This system was not designed with mobile communication devices in mind.

The problem with these and other solutions is that they do not provide a simple voice interactive solution for communication devices that allows simple management of multiple back-end processing services. Currently, users are forced to use disparate systems that make the process of accessing back-end services more complicated.

### SUMMARY

The system and method are directed to solving these and other problems and disadvantages of the prior art. The system and method described herein allow a simplified interactive solution for providing access to back-end services. A communication is established from a communication device to a processing system. The processing system receives a picture from the communication device. The user is presented with a task (service to perform on the picture) on an IVR menu in an Interactive Voice Response (IVR) system. The user responds by choosing a task to perform on the picture. The task is then performed on the picture.

Some of the tasks that can be performed are to generate postcards/greeting cards based on pictures. These can be combined with other services such as photo processing services/delivery services to provide a rich set of services to the user.

### BRIEF DESCRIPTION OF THE DRAWING

These and other features and advantages of the system and method will become more apparent from considering the following description of an illustrative embodiment of the system and method together with the drawing, in which:

FIG. 1 is a block diagram of a first illustrative system for processing a response for a picture.

FIG. 2 is a flow diagram of a method for processing a response for a picture.

FIG. 3 is a flow diagram of a method for processing a voice response for printing text on a photograph/postcard.

FIG. 4 is a flow diagram of a method for associating a voice response with a device in a greeting card.

FIG. 5 is a flow diagram of a method of using location to select services/tasks.

### DETAILED DESCRIPTION

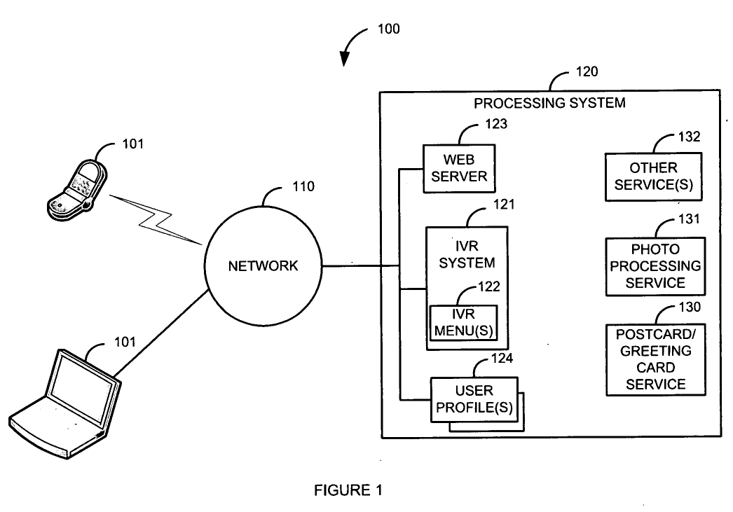

FIG. 1 is a block diagram of a first illustrative system 100 for processing a response for a picture. The first illustrative system 100 comprises a communication device(s) 101, a network 110, and a processing system 120. The communication device(s) 101 can be any device that can communicate over a network 110 such as a cellular telephone, a Personal Digital Assistant (PDA), a Personal Computer (PC), a telephone, and the like. The communication device 101 is typically a mobile communication device, but does not have to be. The communication device 101 will also contain a camera (not shown). The network 110 can be any type of network such as the Internet, a cellular network, a wireless network, a wired network, a packet switched network, a non-packet switched network, a combination of various networks, and the like.

The processing system 120 further comprises an Interactive Voice Response (IVR) system 121, a web server 123, user profiles 124, a postcard/greeting card service 130, a photo processing service 131, and other services 132. The processing system 120 can be any type of device that can communicate with communication devices 101 such as a Private Branch Exchange (PBX), a server, a switch, and the like. The IVR system 121 can be any device that can process voice responses such as a PBX, a server, a switch, and the like. The IVR system 121 can be part of various devices including, but not limited to the communication device 101, a contact center, the web server 123, a server, and a PBX. The IVR system 121 comprises one or more IVR menus 122. The IVR menus 122 are voice messages that are played to a user in order to solicit a response from the user. For example, the user may be asked to hit *1 to add text to a picture and *2 to generate a photograph from a picture. The web server 123 can be used in conjunction with the IVR system 121 to provide more services to the user. The web server 123 can be any device that is capable of presenting web pages.

The user profile(s) 124 contain preferences by the user on how to process a task for a picture. For example, the user profile 124 can contain information such as: where to send the picture, who to send the picture to, how to process the picture, additional tasks to do to the picture, other services 132 to use in conjunction with the picture, which processing service 130-132 to use based on a location of the communication device 101, where to send the picture based on the location of the communication device 101, who to send the picture to based on the location of the communication device 101, combinations of these, and the like. The postcard/greeting card service 130 can be any service capable of generating and/or sending postcards and/or greeting cards. The photo processing service 131 can be any service capable of processing photographs such as printing photographs and the like. Other services 132 can include services such as flower delivery services, food delivery services, gift delivery services, and the like. The services 130-132 can be separate from of the processing system 120.

The communication device 101 takes a picture(s). A voice communication is established between the communication device 101 and the processing system 120. In addition, other communications can be established. For example, an additional communication can also be established with the web server 123. Establishing the communication can be done by either the processing system 120 and/or the communication device 101. The communication can be established in a variety of ways such as: automatically upon taking a picture, automatically upon taking a defined number of pictures, based on a preference in a user profile 124, based on a user selection (e.g. the user hitting a button), and the like. The processing system 120 receives the picture(s).

The user is presented with an IVR menu 122. The IVR menu 122 can comprise one or more questions that are asked of the user of the communication device 101. The questions can comprise one or more tasks that the user selects by responding to the questions. A task is anything that can be done to or in combination with the photograph. For example, a task could be creating a postcard from the picture, adding text to the picture, adding a user response to a greeting card that contains the picture, adding the picture to the greeting card, mailing the postcard, mailing the greeting card, adding a signature to the picture, sending the postcard in combination with flowers or other deliveries, sending a postcard with flowers, and the like. The user responds from the communication device 101 to the one or more IVR menus 122 and indicates which task to perform on the picture. The task(s) are then performed on the picture. The task(s) can be performed by the processing system 120, by the postcard/greeting card service 130, by the photo processing service 131, by other services 132, and/or any combination of the above.

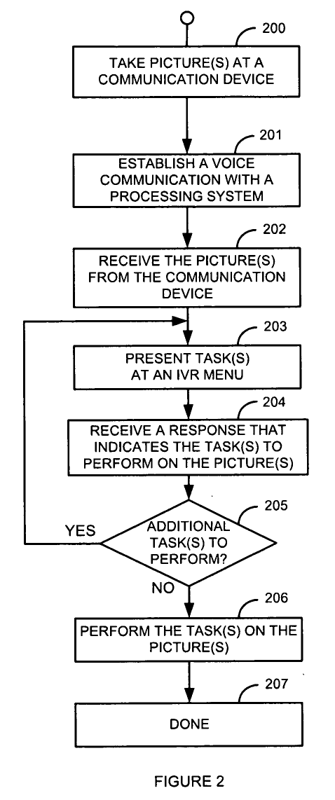

FIG. 2 is a flow diagram of a method for processing a response for a picture. Illustratively, the communication device 101, the processing system 120, the web server 123, the IVR system 121 are stored-program-controlled entities, such as a computer, which performs the method of FIGS. 2-5 by executing a program stored in a storage medium, such as a memory or disk.

The process begins when a picture(s) is taken 200 at a communication device 101. A voice communication is established 201 between the communication device 101 and the processing system 120. The processing system 120 receives 202 the picture(s) from the communication device 101. The user at the communication device 101 is presented 203 with a task(s) at an IVR menu 122. The IVR system 121 receives 204 a response from the communication device 101 that indicates the task(s) to perform. The response in step 204 can be a voice response (e.g. the user saying something in response to the IVR menu 122). The response in step 204 could be where the user enters numbers/pushes buttons on their phone 101 in response to the IVR menu 122. The processing system 120 determines 205 if any additional task(s) need to be performed. For example, additional tasks could include tasks that are requested at a second IVR menu 122. If there are additional task(s) to be performed in step 205, the process goes to step 203 and the user is presented 203 with the additional tasks. If there are no additional tasks to perform in step 205, the processing system 120 performs 205 the task(s) on the picture(s) that were indicated in the response(s) from step 204. The process is then done 207.

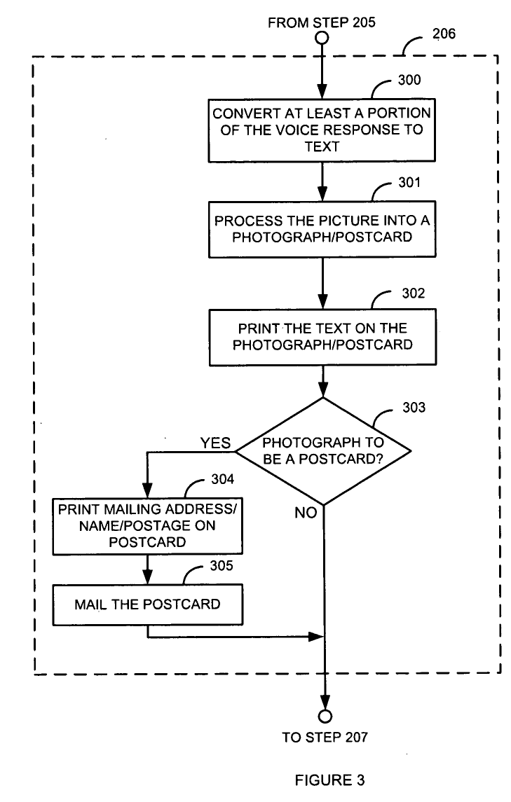

FIG. 3 is a flow diagram of a method for processing a voice response for printing text on a photograph/postcard. FIG. 3 is a flow diagram of step 206 in FIG. 2. The method in FIG. 3 is performed if the received response in step 204 indicates the task of adding text to a photograph and/or generating a postcard. After step 205, the processing system 120 converts 300 at least a portion of the response to text. The voice response could be where the user speaks in response (step 204) to an IVR menu 122. For example, the user may be asked for what text he/she wants printed on the photograph/postcard, the addressee of the postcard, and the address of the addressee. The user's speech is converted 300 to text using known techniques. The picture is processed 301 into a photograph/postcard (e.g. a digital picture is printed onto photograph paper). The text from the voice response is printed 302 on the photograph/postcard. The text can be printed on the front and/or back of the photograph/postcard. Steps 301-302 can be done at the same time by adding the text to a picture prior to printing. Likewise, step 304 could also be done at the same time as steps 301-302.

If the photograph is to be used as a postcard in step 303, the processing system 120 prints 304 a mailing address (of the addressee), name of the addressee, and/or postage on the postcard. The postcard is then mailed 305 and the process goes to step 207. Otherwise, if the photograph is not a postcard in step 303, the process goes to step 207.

An example of the system and method described in FIGS. 1-3 are explained in the following description. A user at a picture phone 101 takes 200 ten pictures. The picture phone 101 automatically, upon taking the tenth picture establishes 201 a voice communication with the processing system 120. The ten pictures are received 202 at the processing system 120 from the picture phone 101.

The user is presented 203 with an IVR menu 122 from the IVR system 120 that indicates to hit *1 to process the photographs, *2 to generate a postcard, or *3 for other options. The user enters *2 (step 204). The user is presented with a second IVR menu 122 asking the user to enter the photograph number (1-10) to be used on the postcard (step 203). The user hits 1 (step 204) to select the first picture. The user is presented with a third IVR menu 122 and is asked to “after the beep to say something that you want printed on the postcard followed by the # key” (step 203). The user says “having fun in Hawaii” followed by the # key (step 204). The response said by the user is converted 300 to text. A postcard is then processed 301 by the postcard/greeting card service 130. The postcard is printed 302 using the text from the voice response. A mailing address, name of the addressee and/or postage is printed 304 on the postcard. The mailing address, name of the addressee and can be obtained from user profiles 124 and/or from responses from the user to IVR menu(s) 122. The postcard is then mailed 305 to the addressee by the postcard/greeting card service 130 using standard mail and/or email. Other information such as a signature (stored in the profile or entered on a web server 123 page) can be printed on the postcard.

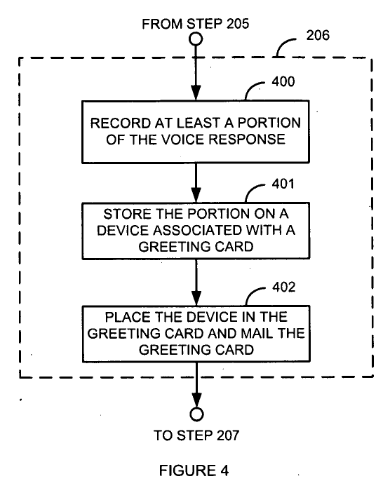

FIG. 4 is a flow diagram of a method for associating a voice response with a device in a greeting card. FIG. 4 is a flow diagram of step 206 in FIG. 2. The method in FIG. 4 is performed if the received response in step 204 indicates the task of recording the voice response and storing the voice response on a device associated with a greeting card.

After step 205, the processing system 120 records 400 at least a portion of the voice response. For example, the user could say in response to an IVR menu 122 that indicates what text the user wants to record in step 204: “Congratulations on your promotion, from John.” The voice response is recorded 400. The recorded voice response is stored 401 on a device associated with a greeting card. A device associated with a greeting card can be a device that plays a message when the greeting card is opened. The device is placed 402 in the greeting card and the greeting card is mailed. The greeting card can be mailed based on user profile 124 and/or based on responses to IVR menu(s) 122.

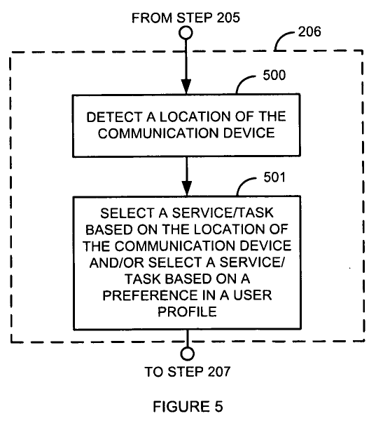

FIG. 5 is a flow diagram of a method of using location to select services/tasks. FIG. 5 is a flow diagram of step 206 in FIG. 2. The method in FIG. 5 is performed if a preference in a user profile 124 and/or a response from the user indicates to select a service/task based on the user profile 124. The method of FIG. 5 can also be performed if the user profile 124 indicates a default service/task is to be performed.

After step 205, the processing system 120 detects 500 a location of the communication device 101. This can be done in a variety of ways such as using Global Positioning Satellites (GPS) or other known techniques. For example, the communication device 101 can report its position to the processing system 120. The processing system 120 selects 501 a service 130-132 and/or task to be performed by the service 130-132 based on the location of the communication device 101, the service and/or task is selected based on one or more preferences in the user profile 124. The process then goes to step 207.

An example of how the method of FIG. 5 can work is described in the following example. Joe sets up a preference in his user profile 124 that indicates if he is in town to send processed photographs to his home address. If Joe is out of town, Joe's user profile 124 indicates to send the processed photographs to a store closest to his location and notify him of the address of where to pick up the photographs.

Of course, various changes and modifications to the illustrative embodiment described above will be apparent to those skilled in the art. These changes and modifications can be made without departing from the spirit and the scope of the system and method and without diminishing its attendant advantages. It is therefore intended that such changes and modifications be covered by the following claims except insofar as limited by the prior art.

The term “a” or “an” entity refers to one or more of that entity. As such, the terms “a” (or “an”), “one or more” and “at least one” can be used interchangeably herein. It is also to be noted that the terms “comprising”, “including”, “containing” and “having” can be used interchangeably.

What is claimed is:

1. A system comprising:
a. a processing system configured to establish a voice communication between a communication device and the processing system, to receive a picture from the communication device, and to perform a task on the picture;
b. an Interactive Voice Response (IVR) system configured to present the task on an IVR menu and to receive a response from the communication device that indicates the task to perform on the picture.

2. The system of claim 1, wherein at least a portion of the response is a voice response, and further comprising a photo processing service configured to convert the voice response to text, process the picture into a photograph, and print the text on the photograph.

3. The system of claim 1, wherein at least a portion of the response is a voice response and further comprising a postcard/greeting card service configured to convert the voice response to text, print the picture as a postcard, print the text on the postcard, print a mailing address on the postcard, and mail the postcard.

4. The system of claim 3, wherein the postcard/greeting card service is further configured to print an addressee name and/or postage on the postcard.

5. The system of claim 1, wherein at least a portion of the response is a voice response and further comprising a postcard/greeting card service configured to record at least a portion of the voice response and store the recorded portion of the voice response on a device associated with a greeting card.

6. The system of claim 1, wherein the interactive voice response system is part of at least one device selected from the group comprising: the communication device, a contact center, a server, and a Private Branch Exchange (PBX).

7. The system of claim 1, wherein the task is at least one or more of the following: creating a postcard, adding text to the picture, adding the response to a greeting card that contains the picture, adding the picture to the greeting card, mailing the postcard, mailing the greeting card, and adding a signature to the picture.

8. The system of claim 7, wherein the task is further associated with a service selected from the following: a photo processing service, a postcard/greeting card service, and a delivery service.

9. The system of claim 1, further comprising a communication device that takes the picture and establishes the communication.

10. The system of claim 9, wherein the communication is established by one of the following: automatically upon taking the picture, automatically based on taking a defined number of pictures, based on a user profile, and based on a user selection.

11. The system of claim 1, wherein the processing system further comprises a user profile containing information for determining at least one of the following tasks: where to send the picture, who to send the picture to, how to process the picture, additional tasks to do to the picture, other services to use in conjunction with the picture, which processing service to use based on a location of the communication device, where to send the picture based on the location of the communication device, and who to send the picture to based on the location of the communication device.

12. The system of claim 1, wherein the processing system is further configured to detect a location of the communication device, and select a service and/or task based on the location of the communication device and/or select the service and/or task based on a preference in a user profile.

13. A method comprising:
a. establishing a voice communication between a communication device and a processing system;
b. receiving a picture from the communication device;
c. presenting a task on an IVR menu on an Interactive Voice Response (IVR) system;
d. receiving a response from the communication device that indicates the task to perform on the picture; and
e. performing the task on the picture.

14. The method of claim 13, wherein at least a portion of the response is a voice response and further comprising the steps of:
f. converting the voice response to text;
g. processing the picture into a photograph; and
h. printing the text on the photograph.

15. The method of claim 14, wherein the photograph is a postcard and further comprising the steps of:
i. printing a mailing address on the postcard; and
j. mailing the postcard.

16. The method of claim 15, further comprising the steps of:
k. printing an addressee name and/or postage on the postcard.

17. The method of claim 13, wherein at least a portion of the response is a voice response and further comprising the steps of:
f. recording at least a portion of the voice response; and
g. storing the recorded portion of the voice response on a device associated with a greeting card.

18. The method of claim 13, wherein the interactive voice response system is part of at least one device selected from the group comprising: the communication device, a contact center, a server, and a Private Branch Exchange (PBX).

19. The method of claim 13, wherein the task is at least one or more of the following: creating a post card, adding text to the picture, adding an audio message to a greeting card that contains the picture, adding the picture to the greeting card, mailing the postcard, mailing the greeting card, and adding a signature to the picture.

20. The method of claim 19, wherein the task is further associated with a service selected from the following: a photo processing service, a postcard/greeting card service, and a delivery service.

21. The method of claim 13, further comprising the steps of:
f. taking the picture at the communication device; and
g. establishing the communication from the communication device.

22. The method of claim 21, wherein the communication is established by one of the following steps: automatically upon taking the picture, automatically based on taking a defined number of pictures, based on a user profile, and based on a user selection.

23. The method of claim 13, wherein the interactive voice response system further comprises a user profile, wherein the user profile contains information to determine at least one of the following tasks: where to send the picture, who to send the picture to, how to process the picture, additional tasks to do to the picture, other services to use in conjunction with the picture, which processing service to use based on presence, where to send the picture based on presence, and who to send the picture to based on presence.

24. The method of claim 13, further comprising the steps of:
f. detecting a location of the communication device; and
g. selecting a service and/or task based on the location of the communication device and/or selecting the service and/or task based on a preference in a user profile.

25. An apparatus comprising:
a. means for establishing a voice communication between a communication device and a processing system;
b. means for receiving a picture from the communication device;
c. means for presenting a task on an IVR menu on an Interactive Voice Response (IVR) system;
d. means for receiving a response from the communication device that indicates the task to perform on the picture; and
e. means for performing the task on the picture.
